(19) United States
(12) Patent Application Publication
(10) Pub. No.: US 2025/0162772 A1
(43) Pub. Date: May 22, 2025

(54) FLAVOR INFUSING SYSTEM AND RELATED VACUUM DEVICE

(71) Applicant: Universal Trim Supply Co., Ltd., New Taipei City (TW)

(72) Inventors: Aly Khalifa, Raleigh, NC (US); Shih-Sheng Yang, Taipei City (TW); Chih-Wei Yang, Taipei City (TW)

(73) Assignee: Universal Trim Supply Co., Ltd., New Taipei City (TW)

(21) Appl. No.: 18/511,978

(22) Filed: Nov. 16, 2023

(51) Int. Cl. B65D 51/24; A23L 5/30; A47J 47/02; B65D 43/02; B65D 51/16

(52) U.S. Cl. CPC B65D 51/24; A23L 5/30; A47J 47/02; B65D 43/0202; B65D 51/16; A47J 2203/00; B65D 2205/02; B65D 2543/00194

(57) ABSTRACT

A flavor infusing system includes a container kit and a vacuum device. The container kit includes a control valve and a container having receiving space and an opening. The vacuum device can draw the inside air to flow out of the receiving space through the opening or introduce the outside air to flow into the receiving space through the opening. The opening is not fully covered by the control valve for allowing inside air to flow out of the receiving space and allowing outside air to flow into the receiving space when the control valve is located at a first position. The opening is fully covered by the control valve for allowing the inside air to flow out of the receiving space and preventing the outside air from flowing into the receiving space when the control valve is located at a second position. Besides, a related vacuum device is provided.

### BACKGROUND OF THE INVENTION

### 1. Field of the Invention

The present invention relates to a vacuum product, and more specifically, to a flavor infusing system and a related vacuum device.

### 2. Description of the Prior Art

It is a common way to use a vacuum system having a container, e.g., a bag or a box, and a vacuum device, e.g., a vacuum pump, for storing food or infusing food with flavor. However, it still takes too much time to complete flavor infusion by using a conventional vacuum system. Therefore, an improvement is needed.

### SUMMARY OF THE INVENTION

It is an objective of the present invention to provide a flavor infusing system and a related vacuum device.

In order to achieve the aforementioned objective, the present invention discloses a flavor infusing system. The flavor infusing system includes a container kit and a vacuum device. The container kit includes a container and a control valve. A receiving space is formed inside the container. An opening is formed on the container and communicated with the receiving space. The control valve is detachably mounted on the container and movable relative to the container between a first used position and a second used position. The opening is not fully covered by the control valve for allowing inside air to flow out of the receiving space through the opening and allowing outside air to flow into the receiving space through the opening when the control valve is located at the first used position. The opening is fully covered by the control valve for allowing the inside air to flow out of the receiving space through the opening and preventing the outside air from flowing into the receiving space through the opening when the control valve is located at the second used position. The vacuum device is for drawing the inside air to flow out of the receiving space through the opening or introducing the outside air to flow into the receiving space through the opening.

According to an embodiment of the present invention, the container includes a receiving portion and a covering portion detachably mounted on the receiving portion. The opening is formed on the covering portion, and the receiving space is formed between the receiving portion and the covering portion.

According to an embodiment of the present invention, a concave structure is formed on the covering portion, and the opening is formed on a wall of the concave structure.

According to an embodiment of the present invention, the control valve is disposed through the opening and partially received inside the concave structure when the control valve is mounted on the container.

According to an embodiment of the present invention, a protruding ring is formed on the covering portion and surrounds an outer periphery of the concave structure, and the protruding ring is configured to engage with a sealing component of the vacuum device in a sealing manner.

According to an embodiment of the present invention, the control valve is a one-piece structure and made of a resilient or deformable material.

According to an embodiment of the present invention, the control valve includes a base portion, a first lid portion and a second lid portion. The first lid portion is integrally connected between the second lid portion and the base portion. The first lid portion and the base portion are located adjacent to an outer side and an inner side of the container respectively and the opening is not fully covered by the first lid portion resting on the outer side of the container for allowing the inside air to flow out of the receiving space through the opening and allowing the outside air to flow into the receiving space through the opening when the control valve is located at the first used position. The first lid portion and the second lid portion are located adjacent to the outer side and the inner side of the container respectively and the opening is fully covered by the second lid portion resting on the outer side of the container for allowing the inside air to flow out of the receiving space through the opening and preventing the outside air from flowing into the receiving space through the opening when the control valve is located at the second used position.

According to an embodiment of the present invention, a dimension of the opening is less than a dimension of the second lid portion and greater than a dimension of the first lid portion.

According to an embodiment of the present invention, the vacuum device includes a circuit board and a vacuum pump electrically connected to the circuit board. The circuit board controls the vacuum pump to draw the inside air out of the receiving space and then stop drawing the inside air out of the receiving space repeatedly for multiple times when the vacuum device is in a first operating mode. The circuit board controls the vacuum pump to draw the inside air out of the receiving space and then stop drawing the inside air out of the receiving space for only one time when the vacuum device is in a second operating mode. The vacuum device is in the first operating mode when the control valve is located at the first used position. The vacuum device is in the second operating mode when the control valve is located at the second used position.

According to an embodiment of the present invention, the vacuum device further includes a solenoid valve electrically connected to the circuit board, and the circuit board further controls the solenoid valve to be opened to introduce the outside air to flow into the receiving space during a period of that the vacuum pump stops drawing the inside air out of the receiving space when the vacuum device is in the first operating mode.

According to an embodiment of the present invention, the vacuum device further includes a one-way valve coupled to a suction end of the vacuum pump.

According to an embodiment of the present invention, the vacuum device further includes a pressure sensor electrically connected to the circuit board and for enabling the circuit board to achieve pressure control

According to an embodiment of the present invention, the vacuum device further includes a timer electrically connected to the circuit board and for enabling the circuit board to achieve time control.

According to an embodiment of the present invention, the vacuum device further includes a drain tube coupled to a discharge end of the vacuum pump.

According to an embodiment of the present invention, the flavor infusing system further includes an isolator and a liquid level sensing mechanism. The isolator is coupled between the vacuum device and the container and configured to provide an isolating space for accommodating liquid flowing out of the receiving space. The liquid level sensing mechanism is configured to sense a liquid level of the liquid inside the isolating space.

According to an embodiment of the present invention, the container is a flexible bag or a hard box.

In order to achieve the aforementioned objective, the present invention further includes a vacuum device adapted for a container kit for flavor infusion. The vacuum device includes a circuit board and a vacuum pump electrically connected to the circuit board. The circuit board controls the vacuum pump to draw inside air out of a receiving space formed inside a container of the container kit and then stop drawing the inside air out of the receiving space formed inside the container repeatedly for multiple times when the vacuum device is in a first operating mode. The circuit board controls the vacuum pump to draw the inside air out of the receiving space formed inside the container and then stop drawing the inside air out of the receiving space formed inside the container for only one time when the vacuum device is in a second operating mode.

According to an embodiment of the present invention, the vacuum device further includes a solenoid valve electrically connected to the circuit board, and the circuit board further controls the solenoid valve to be opened to introduce outside air to flow into the receiving space during a period of that the vacuum pump stops drawing the inside air out of the receiving space when the vacuum device is in the first operating mode.

According to an embodiment of the present invention, the vacuum device further includes a one-way valve coupled to a suction end of the vacuum pump.

According to an embodiment of the present invention, the vacuum device further includes a pressure sensor electrically connected to the circuit board and for enabling the circuit board to achieve pressure control.

According to an embodiment of the present invention, the vacuum device further includes a timer electrically connected to the circuit board and for enabling the circuit board to achieve time control.

According to an embodiment of the present invention, the vacuum device further includes a drain tube coupled to a discharge end of the vacuum pump.

In summary, in the present invention, the vacuum device can be used in different operating modes for different purposes. When it is desired to infuse food with flavor, the vacuum device can be switched to the first operating mode to draw the inside air out of the receiving space formed inside the container and then to stop drawing the inside air out of the receiving space or even to introduce the outside air to flow into the receiving space repeatedly for multiple times, so as to create an oscillating negative pressure environment in the receiving space for facilitating the food to be flavored, i.e., accelerating the flavor infusion. Besides, the vacuum device also can be switched to the second operating mode to create a stable negative pressure environment without pressure oscillation in the receiving space for normal vacuum use.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a flavor infusing system according to a first embodiment of the present invention.

FIG. 2 is a diagram of a container kit of the flavor infusing system according to the first embodiment of the present invention.

FIG. 3 is an exploded diagram of the container kit of the flavor infusing system according to the first embodiment of the present invention.

FIG. 4 is a diagram of a control valve of the container kit of the flavor infusing system according to the first embodiment of the present invention.

FIG. 5 is a top view diagram of a covering portion of a container of the container kit of the flavor infusing system according to the first embodiment of the present invention.

FIG. 6 is a diagram of the flavor infusing system as the control valve is located at a first used position according to the first embodiment of the present invention.

FIG. 7 is a diagram of the flavor infusing system as the control valve is located at a second used position according to the first embodiment of the present invention.

FIG. 8 is a sectional diagram of a vacuum device of the flavor infusing system according to the first embodiment of the present invention.

FIG. 9 is an exploded diagram of the vacuum device of the flavor infusing system according to the first embodiment of the present invention.

FIG. 10 is a functional block diagram of the vacuum device of the flavor infusing system according to the first embodiment of the present invention.

FIG. 11 is a schematic diagram of a flavor infusing system according to a second embodiment of the present invention.

FIG. 12 is an exploded diagram of the flavor infusing system according to the second embodiment of the present invention.

FIG. 13 is a partial section diagram of the flavor infusing system according to the second embodiment of the present invention.

FIG. 14 is a partial functional diagram of the flavor infusing system according to the second embodiment of the present invention.

FIG. 15 is a partial section diagram of a flavor infusing system according to a third embodiment of the present invention.

FIG. 16 is a partial functional diagram of the flavor infusing system according to the third embodiment of the present invention.

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “left”, “right”, “front”, “back”, etc., is used with reference to the orientation of the Figure(s) being described. The components of the present invention can be positioned in a number of different orientations. As such, the directional terminology is used for purposes of illustration and is in no way limiting. Accordingly, the drawings and descriptions will be regarded as illustrative in nature and not as restrictive. Also, if not specified, the term “connect” or “connect” is intended to mean either an indirect or direct electrical/mechanical connection. Thus, if a first device is coupled to a second device, that connection may be through a direct electrical/mechanical connection, or through an indirect electrical/mechanical connection via other devices and connections.

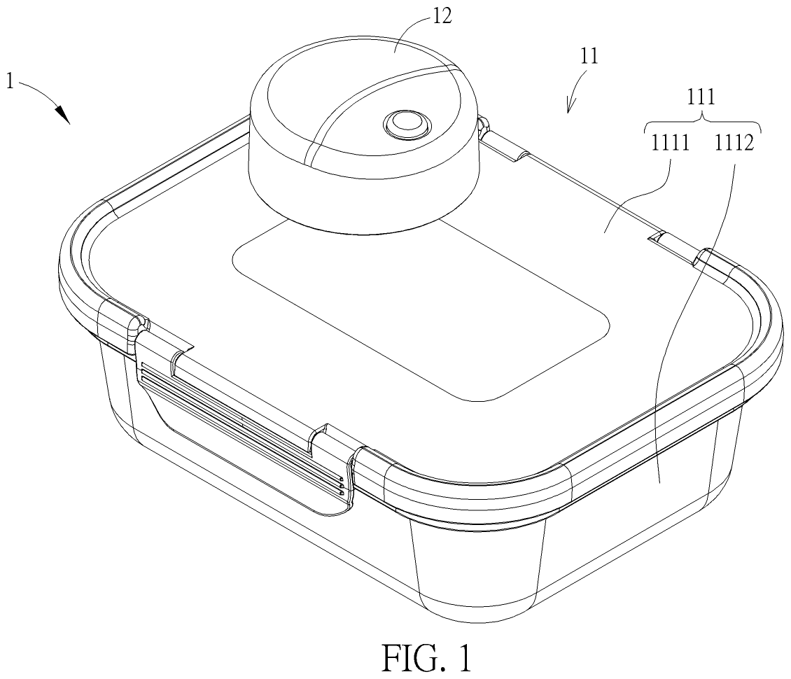

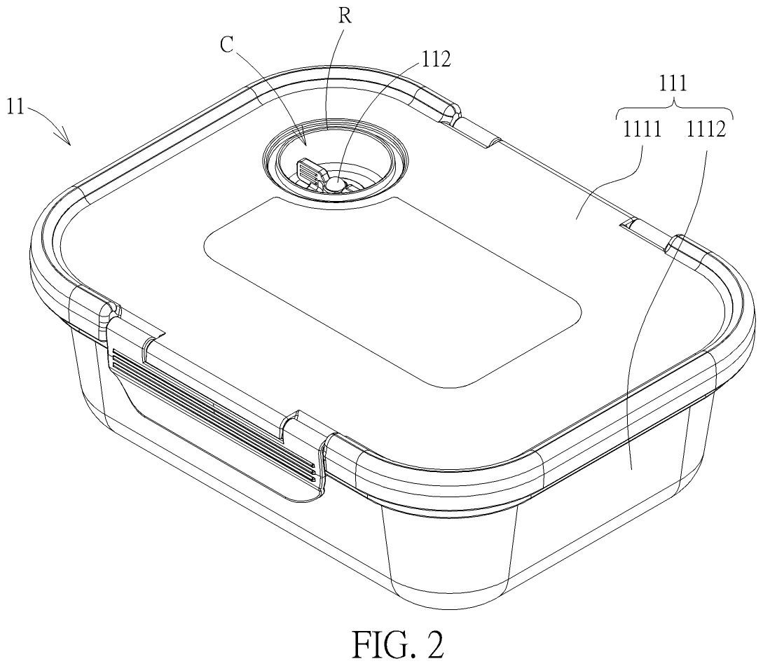

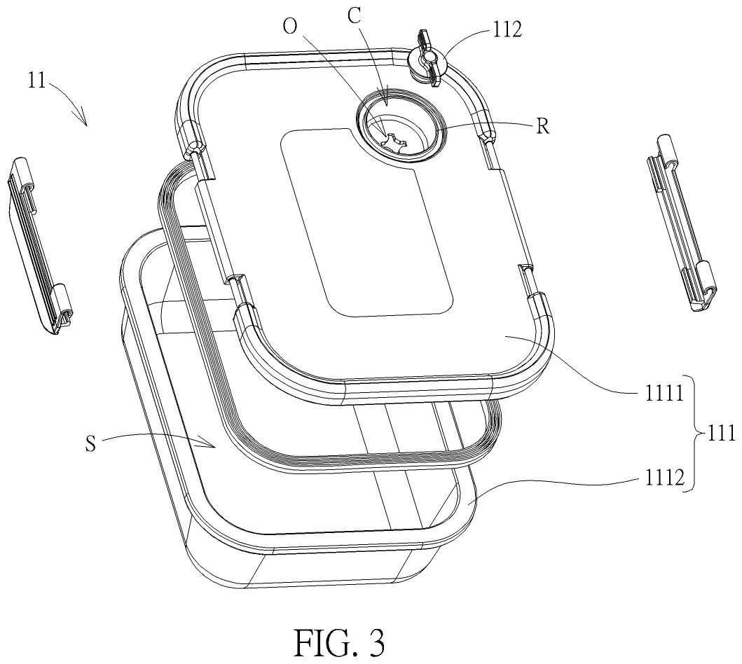

Please refer to FIG. 1 to FIG. 3. FIG. 1 is a schematic diagram of a flavor infusing system 1 according to a first embodiment of the present invention. FIG. 2 is a diagram of a container kit 11 of the flavor infusing system 1 according to the first embodiment of the present invention. FIG. 3 is an exploded diagram of the container kit 11 of the flavor infusing system 1 according to the first embodiment of the present invention. As shown in FIG. 1 to FIG. 3, the flavor infusing system 1 includes the container kit 11 and a vacuum device 12. The container kit 11 includes a container 111 and a control valve 112. A receiving space S is formed inside the container 111 for receiving food and flavoring substances. An opening O is formed on the container 111 and communicated with the receiving space S. The control valve 112 is detachably mounted on the container 111 for allowing one-way air communication or two-way air communication through the opening O. The vacuum device 12 is for drawing inside air to flow out of the receiving space S through the opening O or introducing outside air to flow into the receiving space S through the opening O.

Specifically, as shown in FIG. 2 and FIG. 3, the container 111 includes a receiving portion 1111 and a covering portion 1112 detachably mounted on the receiving portion 1111. More specifically, in this embodiment, the container 111 is a hard box. However, the present invention is not limited to thereto. The opening O is formed on the covering portion 1112, and the receiving space S is formed between the receiving portion 1111 and the covering portion 1112. Preferably, a concave structure C is formed on the covering portion 1112, and the opening O is formed on a wall of the concave structure C. The control valve 112 is disposed through the opening O and partially received inside the concave structure C when the control valve 112 is mounted on the container 111.

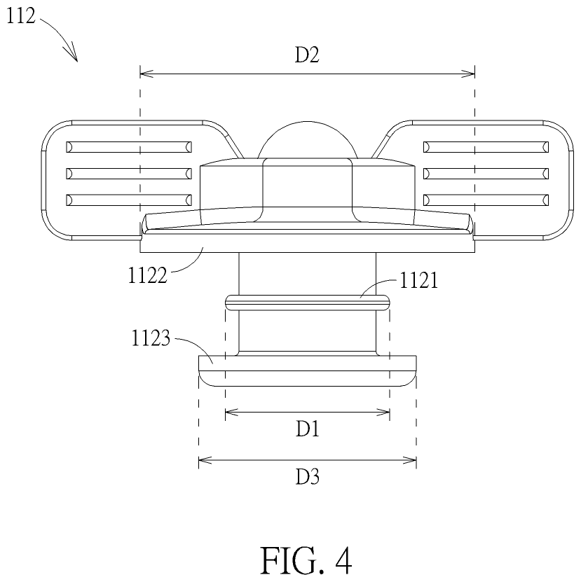

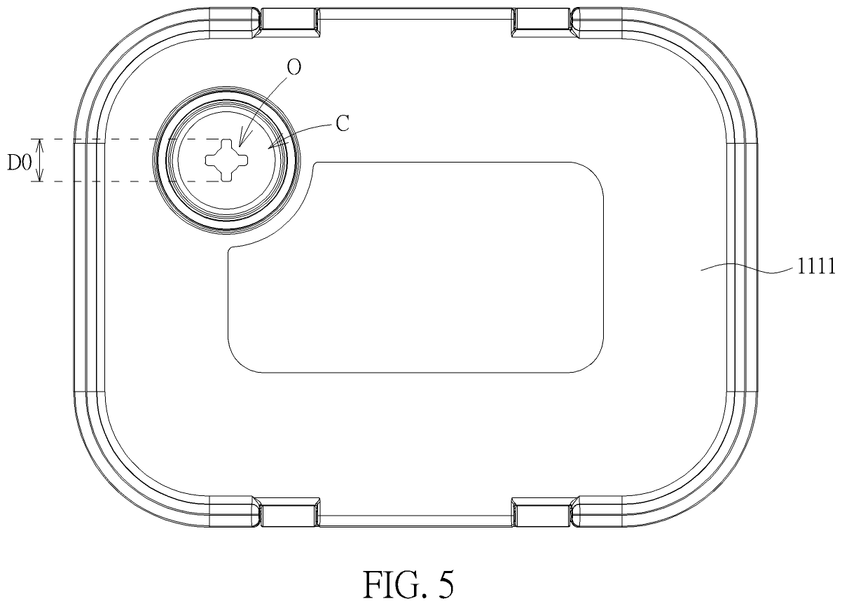

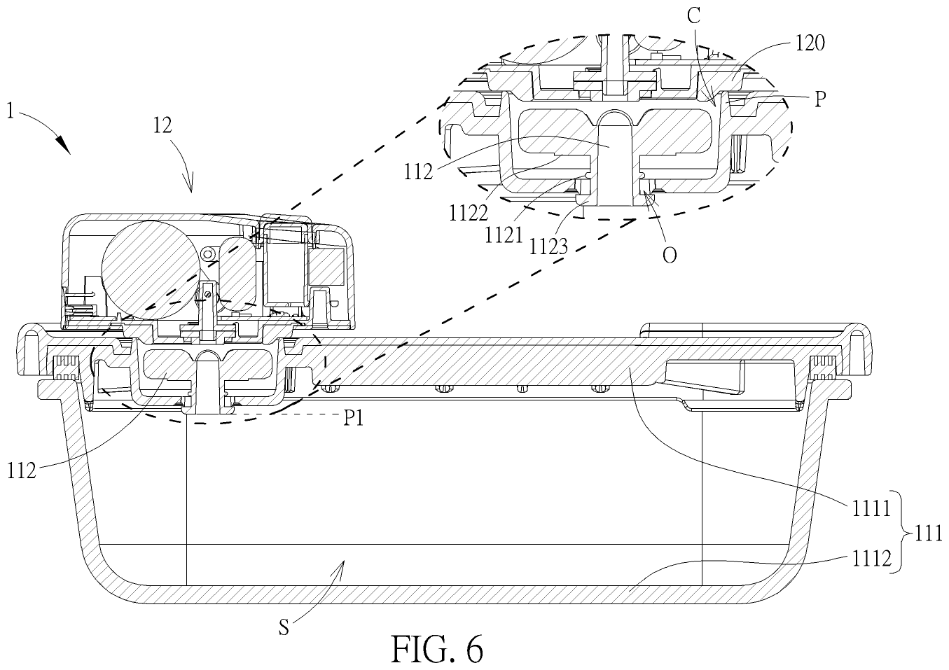

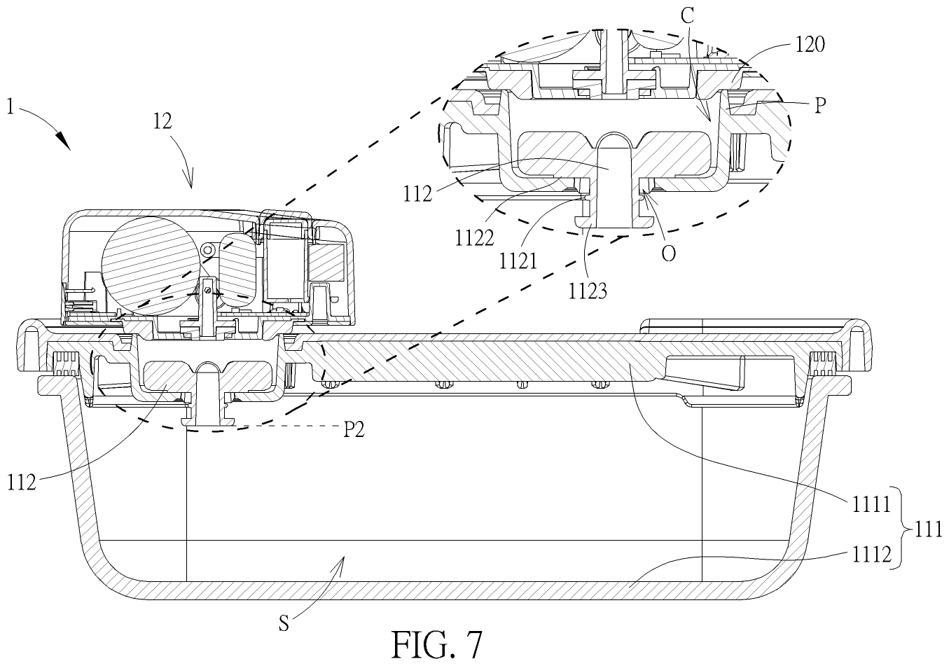

Please refer to FIG. 4 to FIG. 7. FIG. 4 is a diagram of the control valve 112 of the container kit 11 of the flavor infusing system 1 according to the first embodiment of the present invention. FIG. 5 is a top view diagram of the covering portion 1112 of the container 111 of the container kit 11 of the flavor infusing system 1 according to the first embodiment of the present invention. FIG. 6 is a diagram of the flavor infusing system 1 as the control valve 112 is located at a first used position P1 according to the first embodiment of the present invention. FIG. 7 is a diagram of the flavor infusing system 1 as the control valve 112 is located at a second used position P2 according to the first embodiment of the present invention. The control valve 112 is movable between the first used position P1 as shown in FIG. 6 and the second used position P2 as shown in FIG. 7. As shown in FIG. 6, the opening O is not fully covered by the control valve 112 for allowing the inside air to flow out of the receiving space S through the opening O and allowing the outside air to flow into the receiving space S through the opening O, for achieving two-way air communication, when the control valve 112 is located at the first used position P1. As shown in FIG. 7, the opening O is fully covered by the control valve 112 for allowing the inside air to flow out of the receiving space S through the opening O and preventing the outside air from flowing into the receiving space S through the opening O, for achieving one-way air communication, when the control valve 112 is located at the second used position P2.

In order to achieve the aforementioned function of the control valve 112, as shown in FIG. 4, the control valve 112 is a one-piece structure and made of resilient or deformable material. Specifically, the control valve 112 includes a first lid portion 1121, a second lid portion 1122 and a base portion 1123. The first lid portion 1121 is integrally connected between the second lid portion 1122 and the base portion 1123. More specifically, as shown in FIG. 4 and FIG. 5, a dimension, e.g., a diameter D3, of the base portion 1123 is greater than a dimension, e.g., a diameter D1, of the first lid portion 1121 and less than a dimension, e.g., a diameter D2, of the second lid portion 1122. Besides, a dimension, e.g., a distance DO between two distal ends, of the opening O is less than the dimension, e.g., the diameter D2, of the second lid portion 1122 and greater than the dimension, e.g., the diameter D1, of the first lid portion 1121 and the dimension, e.g., the diameter D3, of the base portion 1123. As shown in FIG. 6, when the control valve 112 is located at the first used position P1, the first lid portion 1121 and the base portion 1123 are respectively located adjacent to an outer side and an inner side of the container 111, e.g., an outer side and an inner side of the wall of the concave structure C, and the opening O is not fully covered by the first lid portion 1121 resting on the outer side of the container 111 nor by the second lid portion 1122 for allowing the inside air to flow out of the receiving space S through the opening O and allowing the outside air to flow into the receiving space S through the opening O. As shown in FIG. 7, when the control valve 112 is located at the second used position P2, the first lid portion 1121 and the second lid portion 1122 are respectively located adjacent to the outer side and the inner side of the container 111 and the opening O is fully covered by the second lid portion 1122 resting on the outer side of the container 111 and not fully covered by the first lid portion 1121. At this moment, the second lid portion 1122 resting on the outer side of the container 111 can be resiliently lifted by the inside air drawn by the vacuum device 12 for allowing the inside air to flow out of the receiving space S through the opening O, and the second lid portion 1122 can be resiliently pressed against the outer side of the container 111 by the outside air to seal the opening O for preventing the outside air from flowing into the receiving space S through the opening O.

Preferably, as shown in FIG. 2, FIG. 3, FIG. 6 and FIG. 7, a protruding ring R is formed on the covering portion 1112 and surrounds an outer periphery of the concave structure C, and the protruding ring R is configured to engage with a sealing component 120 of the vacuum device 12 in a sealing manner to achieve an airtight engagement of the vacuum device 12 and the container 111 when the vacuum device 12 is attached on the container 111, e.g., the covering portion 1112 of the container 111. The sealing component 120 can be made of resilient material, such that the sealing component 120 can be resiliently deformed to allow air communication to break the airtight engagement of the vacuum device 12 and the container 111 for easy detachment of the vacuum device 12 from the container 111.

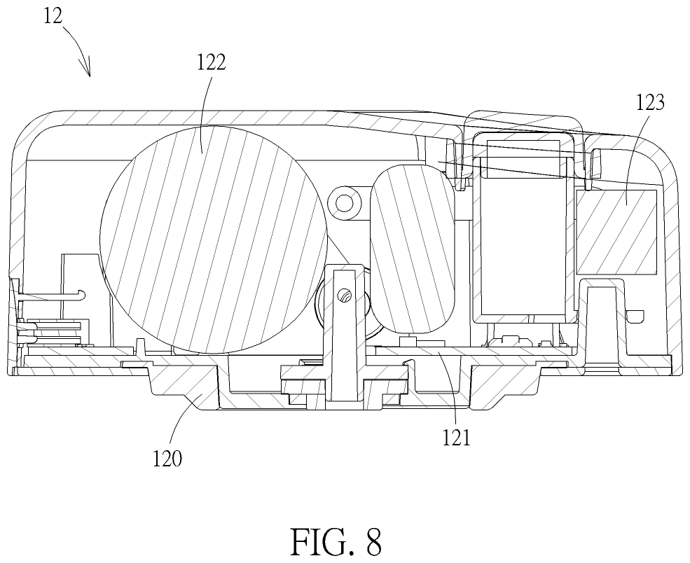

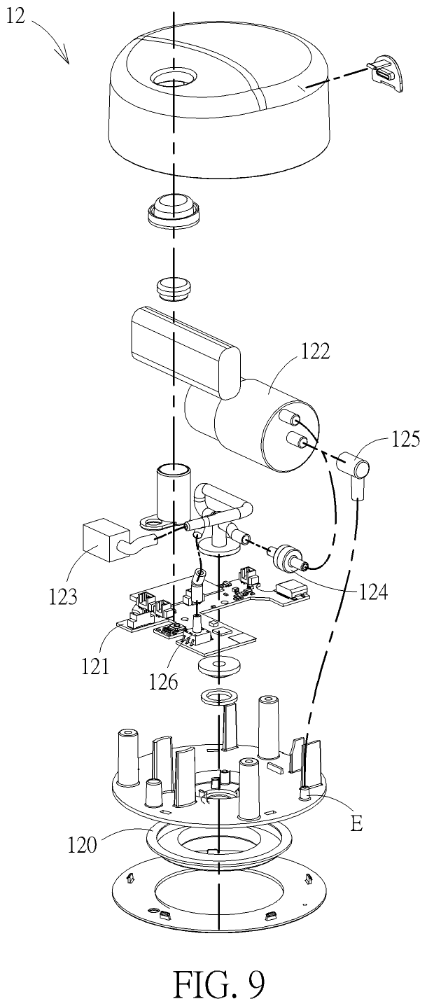

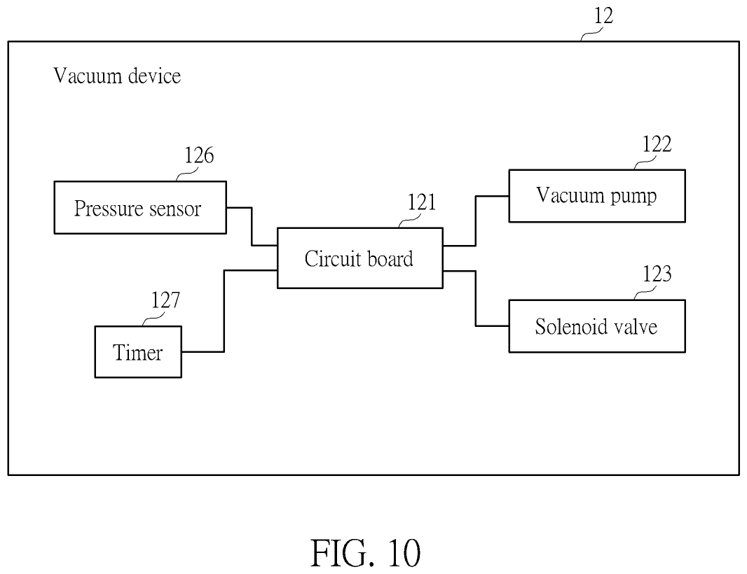

Please refer to FIG. 8 FIG. 10. FIG. 8 is a sectional diagram of the vacuum device 12 of the flavor infusing system 1 according to the first embodiment of the present invention. FIG. 9 is an exploded diagram of the vacuum device 12 of the flavor infusing system 1 according to the first embodiment of the present invention. FIG. 10 is a functional block diagram of the vacuum device 12 of the flavor infusing system 1 according to the first embodiment of the present invention. As shown in FIG. 8 to FIG. 10, the vacuum device 12 includes a circuit board 121 and a vacuum pump 122 electrically connected to the circuit board 121. The circuit board 121 controls the vacuum pump 122 to draw the inside air out of the receiving space S and then to stop drawing the inside air out of the receiving space S repeatedly for multiple times when the vacuum device 12 is in a first operating mode, e.g., a flavor infusion mode. The circuit board 121 further controls the vacuum pump 122 to draw the inside air out of the receiving space S and then to stop drawing the inside air out of the receiving space S for only one time when the vacuum device 12 is in a second operating mode, e.g., a normal mode.

As shown in FIG. 8 to FIG. 10, the vacuum device 12 further includes a solenoid valve 123 electrically connected to the circuit board 121, and the circuit board 121 further controls the solenoid valve 123 to be opened to introduce the outside air to flow into the receiving space S during a period of that the vacuum pump 122 stops drawing the inside air out of the receiving space S when the vacuum device 12 is in the first operating mode. Understandably, the solenoid valve 123 can be replaced by any other pressure regulator.

Preferably, as shown in FIG. 9, in order to achieve air flow control, the vacuum device 12 further includes a one-way valve 124 coupled to a suction end of the vacuum pump 122 for preventing the outside air from flowing through the vacuum pump 122 into the receiving space S.

Preferably, as shown in FIG. 9, in order to prevent damage of internal parts of the vacuum device 12, the vacuum device 12 further includes a drain tube 125 coupled to a discharge end of the vacuum pump 122 and an exit port E of the vacuum device 12 to guide the inside air, which may contain particles and/or moisture, to flow out of the vacuum device 12 directly for preventing internal parts of the vacuum device 12 from being exposed to the particles or the moisture.

Besides, in order to enable the circuit board 121 to achieve pressure control, as shown in FIG. 9 and FIG. 10, the vacuum device 12 further includes a pressure sensor 126 electrically connected to the circuit board 121 and configured to detect a pressure in the receiving space S.

In addition, in order to enable the circuit board 121 to achieve time control, as shown in FIG. 10, the vacuum device 12 further includes a timer 127 electrically connected to the circuit board 121 and configured to count in hours, minutes, or seconds. The timer 127 can be set by a user or by a manufacturer.

By the pressure sensor 126 and the timer 127, for example, for one cycle in the first operating mode, the circuit board 121 can turn on the vacuum pump 122 and close the solenoid valve 123 to draw the inside air out of the receiving space S for decreasing the pressure in the receiving space S down to a first predetermined pressure, e.g., −8.5 psi, for 3 minutes, and then the circuit board 121 can further turn off the vacuum pump 122 and open the solenoid valve 123 to introduce the outside air into the receiving space S for increasing the pressure in the receiving space S up to a second predetermined pressure, e.g., −6.5 psi, for 30 seconds. Furthermore, in the second operating mode, the circuit board 121 can turn on the vacuum pump 122 and close the solenoid valve 123 to decrease the pressure in the receiving space S down to a third predetermined pressure, e.g., −6 psi, and then turn off the vacuum pump 122 to stop drawing the inside air.

It should be noticed that the control valve 112 has to be adjusted to a proper position in response to an operating mode of the vacuum device 12 for ensuring the system to work properly.

As shown in FIG. 6, when it is desired to operate the vacuum device 12 in the first operating mode, the control valve 112 needs to be located at the first used position P1, such that the vacuum device 12 in the first operating mode can create an oscillating negative pressure environment in the receiving space S by introducing the inside air to flow out of the receiving space S and introducing the outside air to flow into the receiving space S, so as to enable the food to be expanded and compressed along with the pressure oscillation for facilitating the food to be flavored, i.e., accelerating the flavor infusion. As shown in FIG. 7, when it is desired to operate the vacuum device 12 in the second operating mode, the control valve 112 needs to be located at the second used position P2, such that the vacuum device 12 in the second operating mode can create a stable negative pressure environment without pressure oscillation in the receiving space S for normal vacuum use.

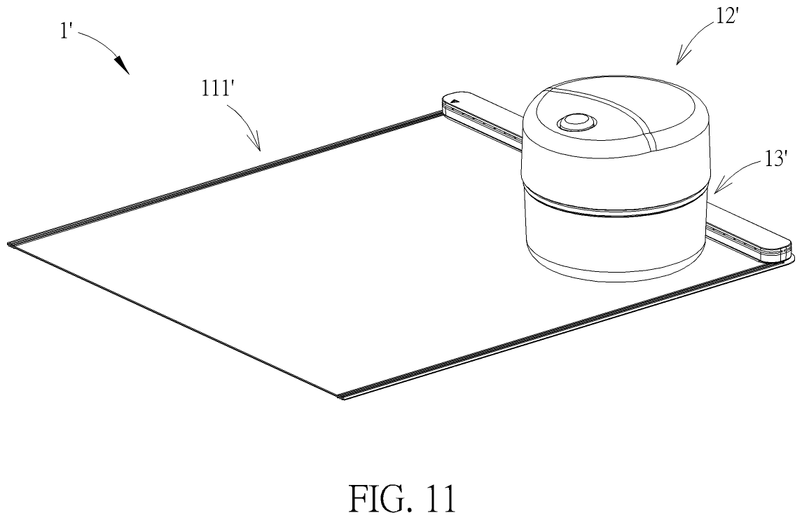

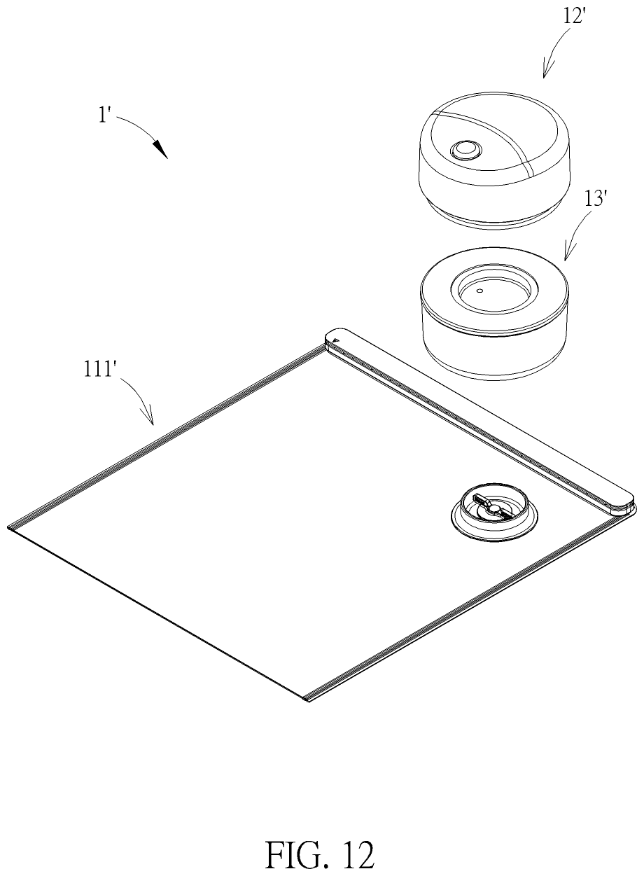

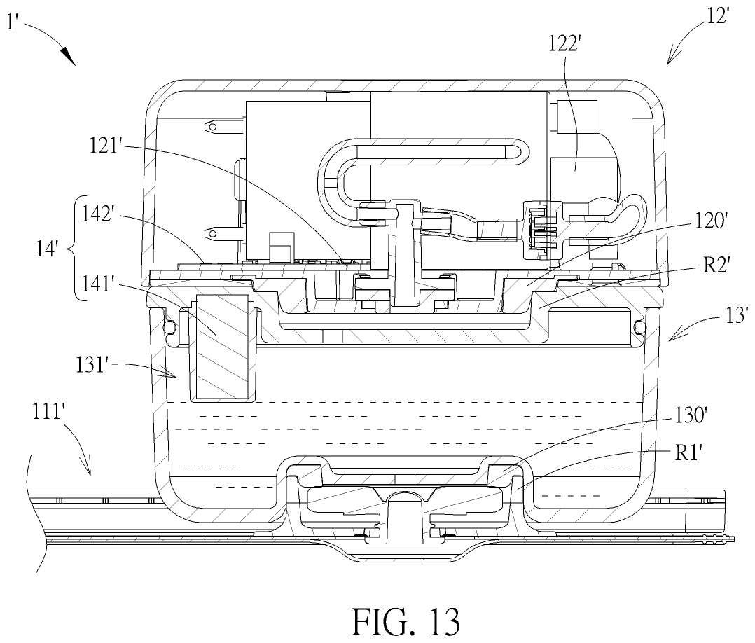

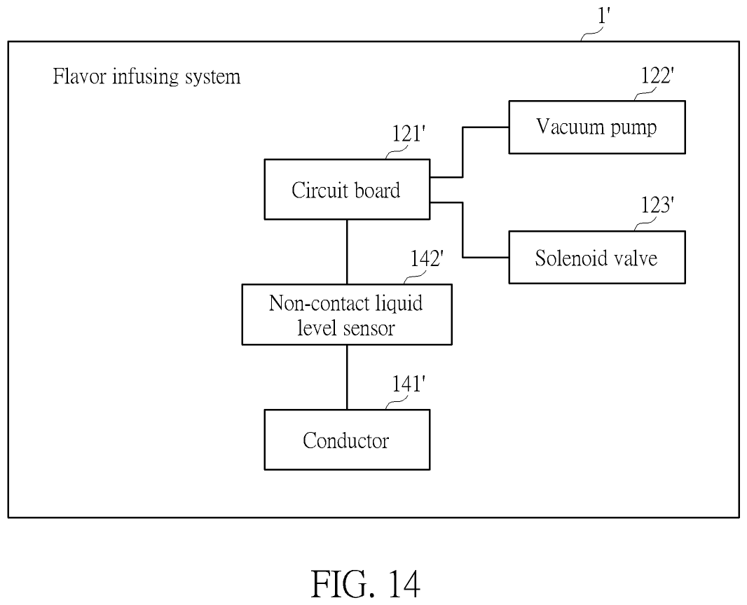

Please refer to FIG. 11 to FIG. 14. FIG. 11 is a schematic diagram of a flavor infusing system 1′ according to a second embodiment of the present invention. FIG. 12 is an exploded diagram of the flavor infusing system 1′ according to the second embodiment of the present invention. FIG. 13 is a partial section diagram of the flavor infusing system 1′ according to the second embodiment of the present invention. FIG. 14 is a partial functional diagram of the flavor infusing system 1′ according to the second embodiment of the present invention. The flavor infusing system 1′ of the second embodiment is similar to the flavor infusing system 1 of the first embodiment. As shown in FIG. 11 to FIG. 14, different from the first embodiment, in the second embodiment, a container 111′ is a flexible bag with a sealer, and the flavor infusing system 1′ further includes an isolator 13′ and a liquid level sensing mechanism 14′. The isolator 13′ is coupled, e.g., detachably connected, between a vacuum device 12′ and the container 111′ and configured to provide an isolating space 131′ for accommodating liquid flowing out of a receiving space formed inside the container 111′. Preferably, a protruding ring R1′ on the container 111′ is configured to engage with a sealing component 130′ of the isolator 13′ in a sealing manner, and an engaging structure R2′ on the isolator 13′ is configured to engage with a sealing component 120′ of the vacuum device 12′ in a sealing manner. The liquid level sensing mechanism 14′ is configured to sense a liquid level of the liquid inside the isolating space 131′. In this embodiment, the liquid level sensing mechanism 14′ can include a conductor 141′ disposed on the isolator 13′ and a non-contact liquid level sensor 142′ disposed inside the vacuum device 12′ and coupled to a circuit board 121′ of the vacuum device 12′. The non-contact liquid level sensor 142′ can cooperate with the conductor 141′ to sense a changed capacitance signal for enabling the circuit board 121′ to achieve liquid level control for preventing the liquid from entering the vacuum device 12′ when the liquid level reaches a bottom of the conductor 141′. For example, the circuit board 121′ can control a vacuum pump 122′ to stop working and/or control a solenoid valve 123′ to be opened according to practical demands when the liquid level reaches the bottom of the conductor 141′. Other details of the second embodiment are the same as the ones of the first embodiment. Detailed description is omitted herein for simplicity.

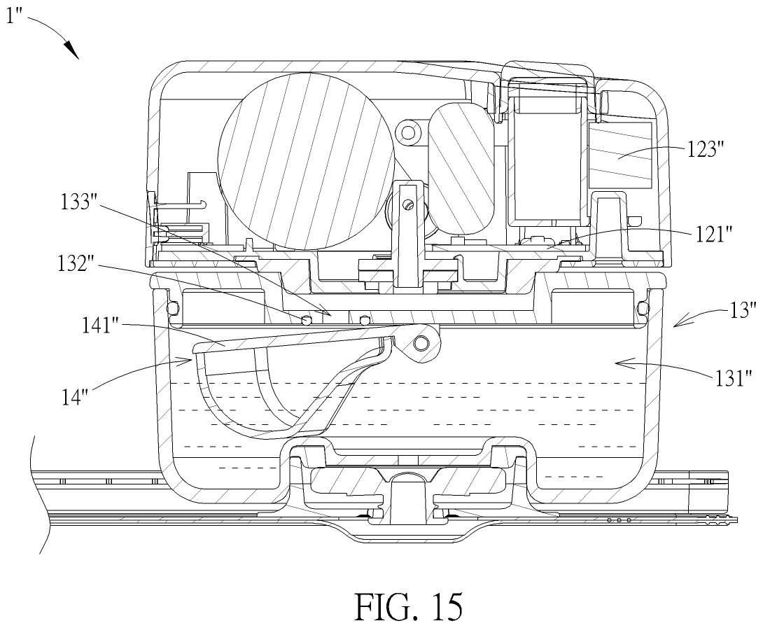

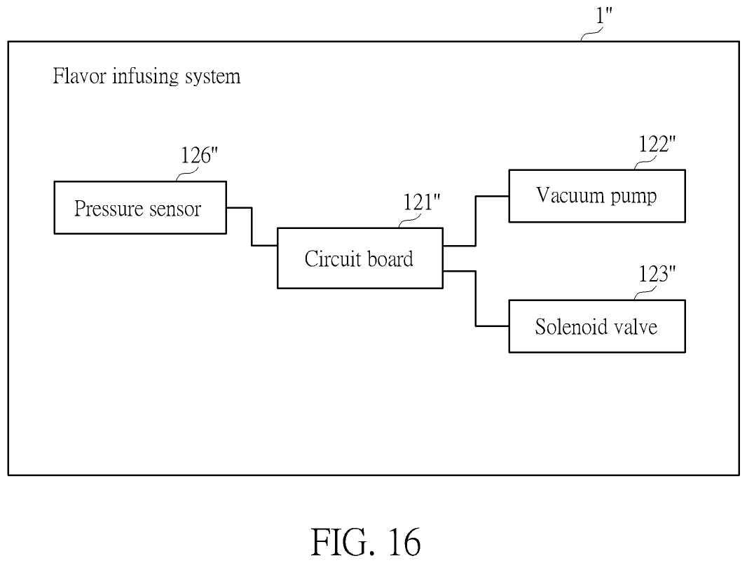

Please refer to FIG. 15 and FIG. 16. FIG. 15 is a partial section diagram of a flavor infusing system 1″ according to a third embodiment of the present invention. FIG. 16 is a partial functional diagram of the flavor infusing system 1″ according to the third embodiment of the present invention. The flavor infusing system 1″ of the third embodiment is similar to the flavor infusing system 1′ of the second embodiment. As shown in FIG. 15 to FIG. 16, different from the second embodiment, in the third embodiment, a liquid level sensing mechanism 14″ can include a floating component 141″ disposed inside an isolating space 131″ of an isolator 13″. When liquid inside the isolating space 131″ increases, the floating component 141″ can be gradually raised by the liquid to abut against an outlet sealing component 132″ of the isolator 13″ for blocking an air outlet 133″ of the isolator 13″. When the floating component 141″ blocks the air outlet 133″ of the isolator 13″, a pressure sensor 126″ can sense an abnormal high pressure, such that a circuit board 121″ can achieve liquid level control accordingly, e.g., the circuit board 121″ can control a vacuum pump 122″ to stop working and/or control a solenoid valve 123″ to be opened according to practical demands. Other details of the second embodiment are the same as the ones of the first embodiment. Detailed description is omitted herein for simplicity.

In contrast to the prior art, in the present invention, the vacuum device can be used in different operating modes for different purposes. When it is desired to infuse food with flavor, the vacuum device can be switched to the first operating mode to draw the inside air out of the receiving space formed inside the container and then to stop drawing the inside air out of the receiving space or even to introduce the outside air to flow into the receiving space repeatedly for multiple times, so as to create an oscillating negative pressure environment in the receiving space for facilitating the food to be flavored, i.e., accelerating the flavor infusion. Besides, the vacuum device also can be switched to the second operating mode to create a stable negative pressure environment without pressure oscillation in the receiving space for normal vacuum use.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A flavor infusing system comprising:
a container kit comprising:
a container, a receiving space being formed inside the container, an opening being formed on the container and communicated with the receiving space; and
a control valve detachably mounted on the container and movable relative to the container between a first used position and a second used position, the opening being not fully covered by the control valve for allowing inside air to flow out of the receiving space through the opening and allowing outside air to flow into the receiving space through the opening when the control valve is located at the first used position, and the opening being fully covered by the control valve for allowing the inside air to flow out of the receiving space through the opening and preventing the outside air from flowing into the receiving space through the opening when the control valve is located at the second used position; and
a vacuum device for drawing the inside air to flow out of the receiving space through the opening or introducing the outside air to flow into the receiving space through the opening.

2. The flavor infusing system of claim 1, wherein the container comprises:
a receiving portion; and
a covering portion detachably mounted on the receiving portion, the opening being formed on the covering portion, and the receiving space being formed between the receiving portion and the covering portion.

3. The flavor infusing system of claim 2, wherein a concave structure is formed on the covering portion, and the opening is formed on a wall of the concave structure.

4. The flavor infusing system of claim 3, wherein the control valve is disposed through the opening and partially received inside the concave structure when the control valve is mounted on the container.

5. The flavor infusing system of claim 3, wherein a protruding ring is formed on the covering portion and surrounds an outer periphery of the concave structure, and the protruding ring is configured to engage with a sealing component of the vacuum device in a sealing manner.

6. The flavor infusing system of claim 1, wherein the control valve is a one-piece structure and made of a resilient or deformable material.

7. The flavor infusing system of claim 1, wherein the control valve comprises a base portion, a first lid portion and a second lid portion, the first lid portion is integrally connected between the second lid portion and the base portion, the first lid portion and the base portion are located adjacent to an outer side and an inner side of the container respectively and the opening is not fully covered by the first lid portion resting on the outer side of the container for allowing the inside air to flow out of the receiving space through the opening and allowing the outside air to flow into the receiving space through the opening when the control valve is located at the first used position, and the first lid portion and the second lid portion are located adjacent to the outer side and the inner side of the container respectively and the opening is fully covered by the second lid portion resting on the outer side of the container for allowing the inside air to flow out of the receiving space through the opening and preventing the outside air from flowing into the receiving space through the opening when the control valve is located at the second used position.

8. The flavor infusing system of claim 7, wherein a dimension of the opening is less than a dimension of the second lid portion and greater than a dimension of the first lid portion.

9. The flavor infusing system of claim 1, wherein the vacuum device comprises a circuit board and a vacuum pump electrically connected to the circuit board, the circuit board controls the vacuum pump to draw the inside air out of the receiving space and then stop drawing the inside air out of the receiving space repeatedly for multiple times when the vacuum device is in a first operating mode, the circuit board controls the vacuum pump to draw the inside air out of the receiving space and then stop drawing the inside air out of the receiving space for only one time when the vacuum device is in a second operating mode, the vacuum device is in the first operating mode when the control valve is located at the first used position, and the vacuum device is in the second operating mode when the control valve is located at the second used position.

10. The flavor infusing system of claim 9, wherein the vacuum device further comprises a solenoid valve electrically connected to the circuit board, and the circuit board further controls the solenoid valve to be opened to introduce the outside air to flow into the receiving space during a period of that the vacuum pump stops drawing the inside air out of the receiving space when the vacuum device is in the first operating mode.

11. The flavor infusing system of claim 9, wherein the vacuum device further comprises a one-way valve coupled to a suction end of the vacuum pump.

12. The flavor infusing system of claim 9, wherein the vacuum device further comprises a pressure sensor electrically connected to the circuit board and for enabling the circuit board to achieve pressure control.

13. The flavor infusing system of claim 9, wherein the vacuum device further comprises a timer electrically connected to the circuit board and for enabling the circuit board to achieve time control.

14. The flavor infusing system of claim 9, wherein the vacuum device further comprises a drain tube coupled to a discharge end of the vacuum pump.

15. The flavor infusing system of claim 9, further comprising an isolator and a liquid level sensing mechanism, the isolator being coupled between the vacuum device and the container and configured to provide an isolating space for accommodating liquid flowing out of the receiving space, the liquid level sensing mechanism being configured to sense a liquid level of the liquid inside the isolating space.

16. The flavor infusing system of claim 1, wherein the container is a flexible bag or a hard box.

17. A vacuum device adapted for a container kit for flavor infusion, the vacuum device comprising:
a circuit board; and
a vacuum pump electrically connected to the circuit board;
wherein the circuit board controls the vacuum pump to draw inside air out of a receiving space formed inside a container of the container kit and then stop drawing the inside air out of the receiving space formed inside the container repeatedly for multiple times when the vacuum device is in a first operating mode;
wherein the circuit board controls the vacuum pump to draw the inside air out of the receiving space formed inside the container and then stop drawing the inside air out of the receiving space formed inside the container for only one time when the vacuum device is in a second operating mode.

18. The vacuum device of claim 17, further comprising a solenoid valve electrically connected to the circuit board, and the circuit board further controlling the solenoid valve to be opened to introduce outside air to flow into the receiving space during a period of that the vacuum pump stops drawing the inside air out of the receiving space when the vacuum device is in the first operating mode.

19. The vacuum device of claim 17, further comprising a one-way valve coupled to a suction end of the vacuum pump.

20. The vacuum device of claim 17, further comprising a pressure sensor electrically connected to the circuit board and for enabling the circuit board to achieve pressure control.

21. The vacuum device of claim 17, further comprising a timer electrically connected to the circuit board and for enabling the circuit board to achieve time control.

22. The vacuum device of claim 17, further comprising a drain tube coupled to a discharge end of the vacuum pump.
